(19) United States
(12) Patent Application Publication
(10) Pub. No.: US 2009/0184913 A1
(43) Pub. Date: Jul. 23, 2009

(54) DISPLAY DEVICE AND ELECTRONIC APPARATUS

(75) Inventor: Masatoshi SATO, Hashima-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-shi (JP)

(21) Appl. No.: 12/325,041

(22) Filed: Nov. 28, 2008

(30) Foreign Application Priority Data
Jan. 23, 2008 (JP) 2008-012283

(51) Int. Cl. G09G 3/36

(52) U.S. Cl. 345/99

(57) ABSTRACT

A display device includes a plurality of pixels, and a time taken for writing a video signal into each of the pixels is changed according to the position of the pixel.

### CROSS-REFERENCE TO RELATED APPLICATION

This application claims priority from Japanese Patent Application No. 2008-012283, filed in the Japanese Patent Office on Jan. 23, 2008, the entire disclosure of which is hereby incorporated by reference in its entirety.

### BACKGROUND

1. Technical Field

The present invention relates to a display device and an electronic apparatus and in particular, to a display device having a plurality of pixels and an electronic apparatus having the same.

2. Related Art

A liquid crystal display device having a plurality of pixels is known (for example, refer to JP-A-2002-221702).

In JP-A-2002-221702, a field sequential liquid crystal display device having a plurality of pixels is disclosed. In the field sequential liquid crystal display device disclosed in JP-A-2002-221702, a screen area of the display device is separated for a predetermined number of pixel lines and a plurality of light sources corresponding to RGB colors are disposed for separated regions of the screen area. In addition, for the respective separated screen regions, writing of image data corresponding to red (R), green (G), and blue (B) and display (display based on a field sequential method) using emission of the light sources are performed.

However, in the liquid crystal display device disclosed in JP-A-2002-221702, the length of a period of writing into a pixel is constant for every separated screen region. For this reason, in the known liquid crystal display device, it is thought that a time required for writing into a pixel (pixel with a largest length of a wiring line to a pixel) which needs a longest writing time is uniformly set as a period of writing into a pixel. Accordingly, in this case, it is thought that periods of writing into all pixels are uniform in spite of a fact that a writing period more than needed is set depending on the position of a pixel. As a result, there is a problem that the total writing period may become long.

### SUMMARY

An advantage of some aspects of the invention is that it provides a display device capable of making a writing period short.

According to a first aspect of the invention, a display device includes a plurality of pixels, and a time taken for writing a video signal into each of the pixels is changed according to the position of the pixel.

In the display device according to the first aspect of the invention, since it is possible to change the writing time of a video signal so as to be shortened by changing the writing time of a video signal according to the position of the pixel as described above, it can be suppressed that the writing period is set to a length larger than that required. Therefore, the writing period can be shortened compared with a case where a fixed writing period is set for all pixels.

In the display device according to the first aspect of the invention, it is preferable to further include signal transmission lines for supplying video signals to the plurality of pixels. Preferably, the time taken for writing a video signal into the pixel is changed according to a distance of each of the signal transmission lines to the pixel. By adopting such a configuration, only a period required for each pixel according to the distance of the signal transmission line can be set as each writing period without uniformly setting a writing time, which is required for a pixel having a longest transmission path of a video signal, as a writing period for each pixel. As a result, the total writing period for all pixels can be shortened.

In this case, preferably, the time taken for writing into the pixel is controlled on the basis of wiring resistance and wiring capacitance of a signal transmission path of the signal transmission line up to the pixel. By adopting such a configuration, the time taken for writing into the pixel is controlled on the basis of the wiring resistance and the wiring capacitance changing with the length (distance of the transmission signal line to the pixel) of a transmission path of a video signal. As a result, the writing time required for each pixel can be correctly set.

In the configuration where the writing time is controlled on the basis of the wiring resistance and wiring capacitance of the signal transmission path, preferably, a control is made such that a writing time becomes long according to an increase in the distance of the signal transmission path to the pixel. By adopting such a configuration, a short writing time is set for a pixel having a short transmission path of a video signal since the wiring resistance and wiring capacitance in the transmission path are small. In addition, for a pixel having a long transmission path of a video signal, the writing time is set to be long since the wiring resistance and the wiring capacitance increase. Accordingly, the total writing time required for all pixels can be reliably shortened.

In the configuration where the writing time is controlled on the basis of the wiring resistance and wiring capacitance of the signal transmission path, preferably, driving based on a line sequential writing method of performing sequential writing for every line is performed for the plurality of pixels, the signal transmission line includes a signal line for supplying a video signal to the pixel, and the time taken for writing into the pixel is controlled on the basis of wiring resistance and wiring capacitance changing with a distance of the signal line to the pixel when writing is performed on the pixels for every line. By adopting such a configuration, in the line sequential writing method, the time taken for writing into a pixel is controlled on the basis of the wiring resistance and wiring capacitance of the signal line for every line of pixels. Accordingly, the writing time can be easily set for each pixel for every line.

In the configuration where the writing time is controlled on the basis of the wiring resistance and wiring capacitance of the signal transmission path, preferably, driving based on a point sequential writing method of performing sequential writing for every pixel is performed, the signal transmission line includes a signal line for supplying a video signal to the pixel and a video signal line for supplying a video signal to each signal line, a switch portion provided between the video signal line and the signal line is further included, and the time taken for writing into the pixel is controlled on the basis of wiring resistance and wiring capacitance changing with a distance of the video signal line to the signal line and a distance of the signal line to the pixel when writing is performed for every pixel. By adopting such a configuration, in the point sequential writing method, the time taken for writing into a pixel is controlled on the basis of the wiring resistance and wiring capacitance of the video signal line and the signal line for every pixel. Accordingly, the writing time required for each pixel can be reliably set.

In the display device according to the first aspect of the invention, it is preferable to further include a counter that converts the position of the pixel into a numeric value and a division ratio setting section that divides a clock signal on the basis of the numeric value converted by the counter. Preferably, the time taken for writing into the pixel is controlled by making the division ratio setting section perform division to a frequency corresponding to the position of the pixel converted into the numeric value by the counter. By adopting such a configuration, the position of a pixel can be correctly distinguished by the counter, and the required writing time can be easily set on the basis of the position of the pixel converted into the numeric value.

In this case, preferably, the plurality of pixels are arrayed in a matrix, the counter is configured to convert the position of the pixel into a numeric value for every line, and the time taken for writing a video signal into the pixel is changed for every line on the basis of the numeric value converted for every line by the counter. By adopting such a configuration, the time taken for writing into the pixel is controlled for every line. Accordingly, a control can be easily made compared with a case where the writing time is individually controlled for every pixel, and it can be suppressed that a circuit becomes complicated.

In the configuration including the counter and the division ratio setting section, preferably, the plurality of pixels are arrayed in a matrix, the counter is configured to convert the position of the pixel into a numeric value for every pixel, and the time taken for writing a video signal into the pixel is changed for every pixel on the basis of the numeric value converted for every pixel by the counter. By adopting such a configuration, the writing time can be controlled according to the position of each pixel, and the required writing time can be set more finely since the writing time is controlled for every pixel. Accordingly, the total writing period can be further shortened as much as a writing time set finely.

In the display device according to the first aspect of the invention, it is preferable to further include a light-emitting device. The light-emitting device is configured to include a plurality of light sources corresponding to a plurality of emission colors, and the plurality of light sources are controlled by field sequential driving controlled to be turned on in order for every color. By adopting such a configuration, for example, in a case where light sources formed of light-emitting diode elements or the like are configured to correspond to red (R), green (G), and blue (B) colors, a desired color can be obtained by spatially displaying and mixing the red (R), green (G), and blue (B) colors with the light-emitting diode elements. Accordingly, it is not necessary to provide a color filter. Accordingly, since the transmittance of light from the light source can be increased in proportion as a color filter is not provided, an image can be displayed with higher brightness.

According to a second aspect of the invention, an electronic apparatus includes the display device described above. By adopting such a configuration, it is possible to obtain an electronic apparatus capable of shortening an image writing period or displaying an image with higher brightness.

### BRIEF DESCRIPTION OF THE DRAWINGS

The invention will be described with reference to the accompanying drawings, wherein like numbers reference like elements.

FIG. 1 is a block diagram illustrating the entire configuration of a liquid crystal display device according to a first embodiment of the invention.

FIG. 2 is an equivalent circuit diagram illustrating a pixel portion of the liquid crystal display device according to the first embodiment of the invention.

FIG. 3 is an equivalent circuit diagram illustrating a pixel portion of the liquid crystal display device according to the first embodiment of the invention.

FIG. 4 is an equivalent circuit diagram illustrating a pixel portion of the liquid crystal display device according to the first embodiment of the invention.

FIG. 5 is an equivalent circuit diagram illustrating a pixel portion of the liquid crystal display device according to the first embodiment of the invention.

FIG. 6 is an equivalent circuit diagram illustrating a pixel portion of the liquid crystal display device according to the first embodiment of the invention.

FIG. 7 is an equivalent circuit diagram illustrating a pixel portion of the liquid crystal display device according to the first embodiment of the invention.

FIG. 8 is a view explaining a writing period of the liquid crystal display device according to the first embodiment of the invention.

FIG. 9 is a view illustrating an example of an electronic apparatus using the liquid crystal display according to the first embodiment of the invention.

FIG. 10 is a view illustrating an example of an electronic apparatus using the liquid crystal display according to the first embodiment of the invention.

FIG. 11 is a block diagram illustrating the entire configuration of a liquid crystal display device according to a second embodiment of the invention.

FIG. 12 is an equivalent circuit diagram illustrating a pixel portion of the liquid crystal display device according to the second embodiment of the invention.

FIG. 13 is an equivalent circuit diagram illustrating a pixel portion of the liquid crystal display device according to the second embodiment of the invention.

### DESCRIPTION OF EXEMPLARY EMBODIMENTS

Hereinafter, embodiments of the invention will be described with reference to the accompanying drawings.

### First Embodiment

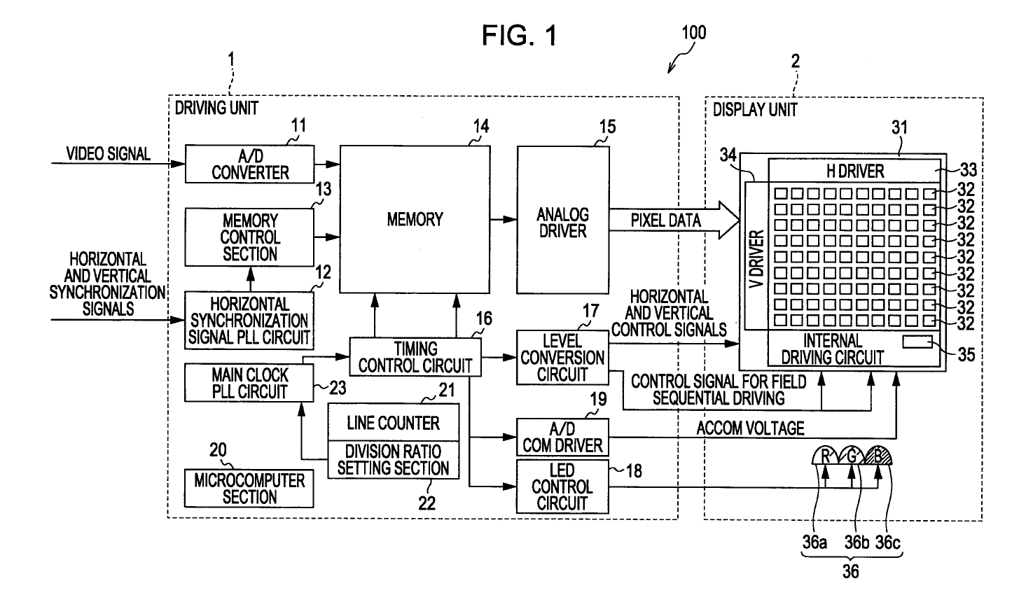

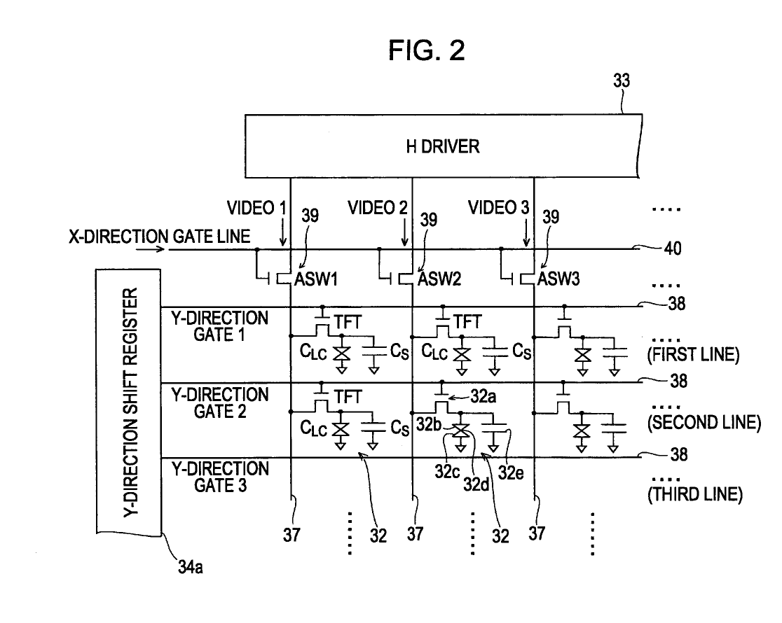

FIG. 1 is a block diagram illustrating the entire configuration of a liquid crystal display device according to a first embodiment of the invention. FIG. 2 is an equivalent circuit diagram illustrating a pixel portion of the liquid crystal display device according to the first embodiment of the invention. First, the configuration of a liquid crystal display device 100 according to the first embodiment of the invention will be described with reference to FIGS. 1 and 2. Moreover, in the first embodiment, a case in which the invention is applied to a liquid crystal display device based on a field sequential driving method, which is an example of a display device, will be described.

The liquid crystal display device 100 according to the first embodiment is configured to include a driving unit 1 and a display unit 2, as shown in FIG. 1.

The driving unit 1 includes an A/D converter 11, a horizontal synchronization signal PLL circuit 12, a memory control section 13, a memory 14, an analog driver 15, a timing control circuit 16, a level conversion circuit 17, an LED control circuit 18, an A/D COM driver 19, and a microcomputer section 20. In addition, in the first embodiment, the driving unit 1 includes a line counter 21, a division ratio setting section 22, and a main clock PLL circuit 23. In addition, the line counter 21 is an example of a ‘counter’ in the invention.

The A/D converter 11, the PLL circuit 12, and the memory control section 13 are connected to each other. The A/D converter 11 has a function of converting an analog video signal into a digital signal corresponding to R (red), G (green), and B (blue). In addition, the horizontal synchronization signal PLL circuit 12 has a function of generating a clock written into the memory 14 from a horizontal synchronization signal and generating a clock required for field sequential driving. In addition, the memory control section 13 has a function of generating a timing signal for storing a video signal converted into the RGB digital signal in the memory 14 for every RGB and generating a call timing signal required for field sequential driving. In addition, the A/D converter 11 and the memory control section 13 are connected to the memory 14. The memory 14 has a function of storing the RGB digital signal.

The analog driver 15 is connected to the memory 14. The analog driver 15 has a function of reading an RGB digital signal stored in the memory 14 and converting the RGB digital signal into an RGB analog signal and of supplying the RGB analog signal to the display unit 2.

The timing control circuit 16 is connected to the memory 14, the level conversion circuit 17, the LED control circuit 18, the A/D COM driver 19, and the main clock PLL circuit 23. In addition, the timing control circuit 16 has a function of generating a timing signal for driving a pixel 32 to be described later. In addition, the level conversion circuit 17 has a function of generating pulses (horizontal and vertical control signals and a control signal for field sequential driving) for driving the pixel 32. In addition, the LED control circuit 18 has a function of controlling emission of an LED 36, which will be described later, and stopping of the emission according to the timing of field sequential driving. In addition, the A/D COM driver 19 has a function of determining a COM voltage to be supplied to a common electrode 32c, which will be described later, and supplying the determined COM voltage to the common electrode 32c.

The microcomputer section 20 is connected to all circuits included in the driving unit 1 (the connected is not shown) and has a function of controlling the overall operation of the driving unit 1.

Here, in the first embodiment, the line counter 21 has a function of converting a line, in which the pixels 32 that perform writing of a video signal are arrayed, into a numeric value. That is, in the first embodiment, the line counter 21 is configured to be able to identify the position of the pixel 32 that performs writing for every line. In addition, the division ratio setting section 22 has a function of dividing a comparison pulse in the main clock PLL circuit 23 on the basis of the position of a line converted into the numeric value by the line counter 21. In addition, the comparison pulse is a pulse for generating a main operation clock and is supplied to the main clock PLL circuit 23. In addition, dividing refers to an operation of lowering a frequency of a predetermined period to one over an integer. In addition, the main clock PLL circuit 23 has a function of generating a main operation clock on the basis of the comparison pulse supplied from the division ratio setting section 22. In addition, the main clock PLL circuit 23 has a function of generating a basic clock required for reading from the memory 14 and driving of the display unit 2.

In addition, the display unit 2 includes a substrate 31, a plurality of pixels 32, an H driver 33 and a V driver 34 connected to the pixels 32, an internal driving circuit 35 for driving the H driver 33 and the V driver 34, and three LEDs (light-emitting diode elements) 36 (36a to 36c) that emit light components corresponding to red (R), green (G), and blue (B) colors and serve as a backlight of the pixels 32. In addition, the LED 36 is an example of a ‘light-emitting device’ in the invention.

In addition, as shown in FIG. 2, a plurality of data lines 37 and a plurality of gate lines 38 are provided on the substrate 31 (refer to FIG. 1) so as to be perpendicular to each other. Each of the data lines 37 is connected to the H driver 33 with a switch portion (ASW) 39 formed of a TFT (thin film transistor) interposed therebetween. In addition, a gate of each switch portion 39 is connected to an X-direction gate line 40. In addition, each of the gate lines 38 is connected to a Y-direction shift register 34a provided in the V driver 34. In addition, the pixels 32 are provided at positions where the data lines 37 and the gate lines 38 cross. Each pixel 32 includes a pixel transistor 32a formed of an n-type TFT, a pixel electrode 32b, a common electrode 32c provided opposite the pixel electrode 32b, liquid crystal 32d held in a state being interposed between the pixel electrode 32b and the common electrode 32c, and an auxiliary capacitor 32e. In addition, a drain region of the pixel transistor 32a is connected to the data line 37, and a source region of the pixel transistor 32a is connected to the pixel electrode 32b and one electrode of the auxiliary capacitor 32e. In addition, a gate of the pixel transistor 32a is connected to a gate line 38. In addition, the data line 37 is an example of a ‘signal line (signal transmission line)’ in the invention.

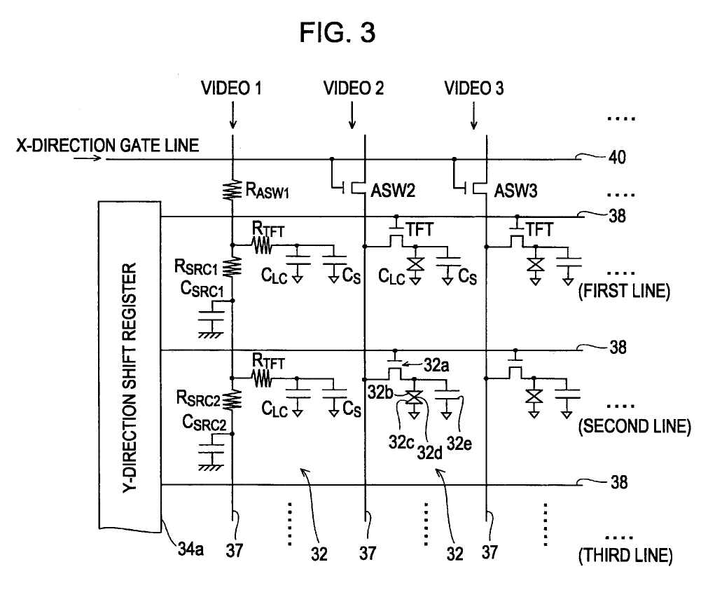

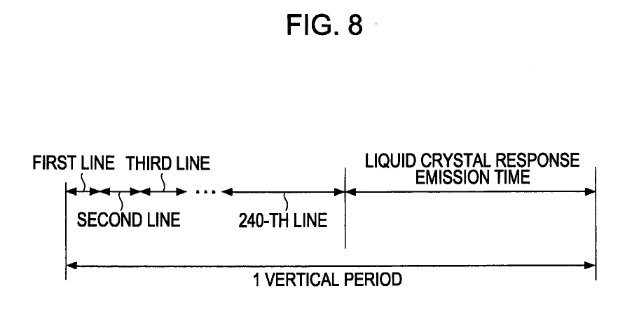

FIGS. 3 to 7 are equivalent circuit diagrams illustrating a pixel portion of the liquid crystal display device according to the first embodiment of the invention. FIG. 8 is a view explaining a writing period of the liquid crystal display device according to the first embodiment of the invention. Then, an operation of the liquid crystal display device 100 according to the first embodiment of the invention will be described with reference to FIGS. 1 to 8.

First, in the driving unit 1, an analog video signal is input to the A/D converter 11 in which the analog video signal is converted into an RGB digital signal, as shown in FIG. 1. In addition, horizontal and vertical synchronization signals are input to the PLL circuit 12. In addition, according to the timing signal (signal stored in the memory 14 for each of signals corresponding to red, green, and blue colors) generated by the memory control section 13, the RGB digital signal converted by the A/D converter 11 is stored in the memory 14.

In addition, a timing signal for writing of RGB image data, a timing signal for switching of the RGB sequence in writing of image data, and a timing signal for emission of the LED 36 are generated by the timing control circuit 16. On the basis of the timing signal for writing of RGB image data and the timing signal for switching of the RGB sequence in writing of image data into the pixel 32 that have been generated by the timing control circuit 16, horizontal and vertical control signals and a control signal for field sequential driving are supplied to the display unit 2 through the level conversion circuit 17. Thus, writing of RGB image data and switching of the RGB sequence in writing of image data into the pixel 32 are performed.

Then, field sequential driving in which writing of a red video signal, emission of the red LED 36a, writing of a green video signal, emission of the green LED 36b, writing of a blue video signal, and emission of the blue LED 36c are performed once during one frame (a period for which one screen is displayed) by a signal from the LED control circuit 18 is performed on the basis of the timing signal for emission of the LED 36 generated by the timing control circuit 16.

Next, an operation in writing a video signal corresponding to each color will be described with reference to FIGS. 1 to 8.

For the operation in writing the above-described video signals, video signals (video1, video 2, . . . in FIG. 2) to be written into the respective pixels 32 are supplied simultaneously from the H driver 33 to the data lines 37 as shown in FIG. 2. Then, an ON signal is supplied from the X-direction gate line 40 to thereby turn on gates of the switch portions 39 simultaneously. At this time, an ON signal starts to be supplied from the Y-direction shift register 34a to the gate line 38 in a sequential manner. As a result, first, video signals corresponding to the pixels 32 on the first line are output simultaneously from the H driver 33 and an ON signal is supplied from the Y-direction shift register 34a to gates of the pixel transistors 32a on the first line. Then, the video signal is supplied to each pixel electrode 32b through each switch portion 39 and between drain and source of each pixel transistor 32a disposed on the first line. As a result, writing is performed on each of the pixels 32 arrayed on the first line. Then, similar to the first line, video signals corresponding to the pixels 32 on the second line are output simultaneously from the H driver 33 and an ON signal is supplied from the Y-direction shift register 34a to gates of the pixel transistors 32a on the second line. As a result, the video signal is supplied to each pixel electrode 32b on the second line to thereby perform writing of each pixel 32 on the second line. Then, by performing the similar operation on the three and subsequent lines, writing based on a line sequential method in which sequential writing is performed for lines is performed in the first embodiment.

In addition, in the first embodiment, a time taken for writing into the pixel 32 is controlled according to a distance of the data line 37 to each pixel 32 when writing a video signal into each pixel 32 for every line. Specifically, the time taken for writing into the pixel 32 is controlled on the basis of the wiring capacitance and wiring resistance of the data line 37 changing with the distance of the data line 37 to the pixel 32. Hereinafter, details thereof will be described.

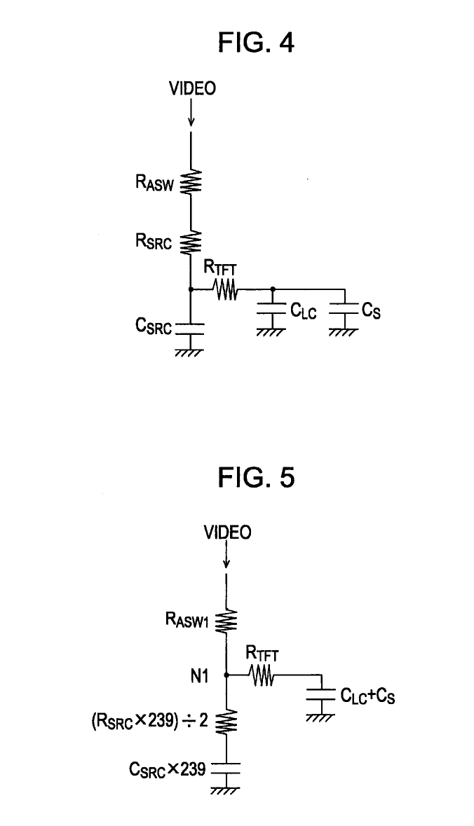

In the display unit 2 including the pixels 32 arrayed in a matrix, the resistance of the switch portion 39 is expressed as R_{ASW1} when a distributed constant circuit of a portion corresponding to the data line 37 on a first column is approximated as an equivalent circuit of a lumped constant circuit, as shown in FIG. 3. In addition, the resistance of the pixel transistor 32a, the capacitance of the pixel electrode 32b and the common electrode 32c, and the capacitance of the auxiliary capacitor 32e are expressed as R_{TFT}, C_{LC}, and C_{S}, respectively. In addition, the wiring resistance and wiring capacitance of the data line 37 on the first column are expressed as R_{SRC1} and C_{SRC1}, respectively. In addition, the wiring resistance and wiring capacitance of the data line 37 on the second column are expressed as R_{SRC2} and C_{SRC2}, respectively. In addition, the wiring resistances and wiring capacitances of the data lines 37 on the third and subsequent rows are expressed as R_{SRC3}, R_{SRC4}, . . . and C_{SRC3}, C_{SRC4}, . . . similar to those on the first and second columns. As a result, a circuit shown in FIG. 4 is obtained as an equivalent circuit in one column.

Thus, for example, in a case where the pixels 32 are arrayed on 240 lines, a circuit shown in FIG. 5 is obtained as an equivalent circuit in the pixels 32 on the first line. At this time, in the pixels 32 on the first line, the wiring resistance and wiring capacitance corresponding to 240 lines exist in a portion of lower lines from a node 1 (N1), which is a connection portion between the switch portion 39 (R_{ASW1}) and the pixel transistor 32a (R_{TFT}), as shown in FIG. 5. That is, 239 wiring resistances (R_{SRC}×239) and 239 wiring capacitances (C_{SRC}×239) exist between the lines. In addition, the wiring resistance becomes a value of (R_{SRC}×239)÷2 since a value when the distributed constant circuit is treated as a lumped constant circuit becomes about ½.

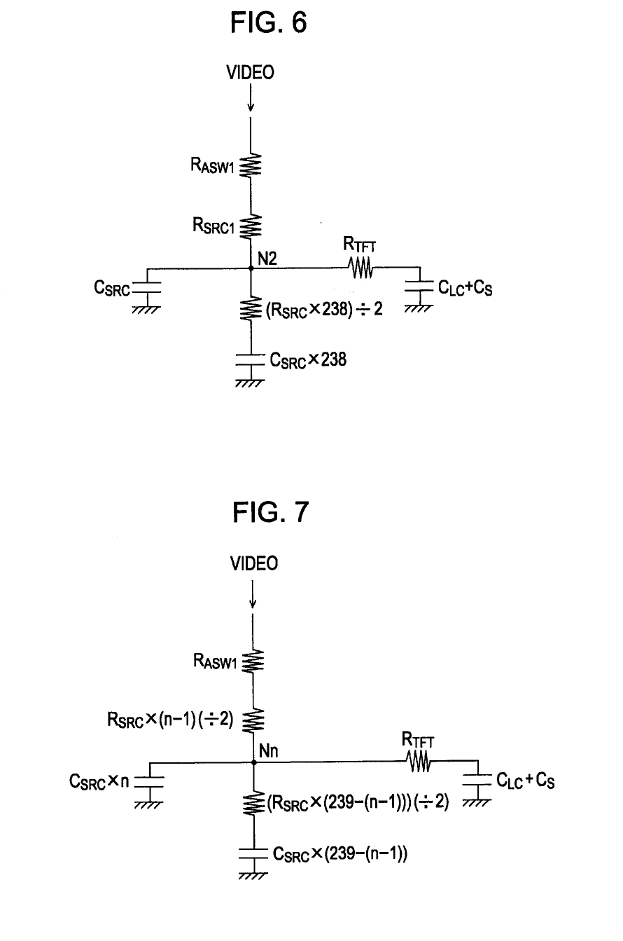

In addition, for example, in a case where the pixels 32 are arrayed on 240 lines, a circuit shown in FIG. 6 is obtained as an equivalent circuit in the pixels 32 on the second line. At this time, in the pixels 32 on the second line, the wiring resistance and wiring capacitance corresponding to 239 lines exist in a portion of lower lines from a node 2 (N2), which is a connection portion between the switch portion 39 (R_{ASW1}) and R_{SRC1} (wiring resistance on the first line) and the pixel transistor 32a, as shown in FIG. 6. That is, 238 wiring resistances (R_{SRC}×238) and 238 wiring capacitances (C_{SRC}×238) exist between the lines.

In addition, for example, in a case where the pixels 32 are arrayed on 240 lines, a circuit shown in FIG. 7 is obtained as an equivalent circuit in the pixels 2 on the n-th (n=1, 2, . . . , 240) line. At this time, in the pixels 32 on the n-th line, the switch portion 39 (R_{ASW1}) and R_{SRC}×(n−1) (wiring resistance up to (n−1) line) exist in a portion of higher lines from a node n (Nn), which is a connection portion between the data line 37 and the pixel transistor 32a, as shown in FIG. 7. In addition, the wiring resistance and wiring capacitance corresponding to 240−(n−1) lines exist in a portion of lower lines from the node n (Nn). That is, 239−(n−1) wiring resistances (R_{SRC}×(239−(n−1))) and 239−(n−1) wiring capacitances (C_{SRC}×(239−(n−1))) exist between the lines. As described above, the wiring resistance and the wiring capacitive exist in each column.

Here, when a distributed constant circuit formed of RC is approximated to a lumped constant circuit, a time constant τ is approximated to τ=nR×nC/2=n²RC/2. In addition, n is the number of resistors R and the number of capacitors C. In addition, the time constant τ is an index showing the response speed of a circuit, and the unit thereof is s (second). In addition, from the above expression, the time constant τ increases as the number of R and C increases. That is, a writing time becomes long as the number of wiring resistors (R_{SRC}) and wiring capacitors (C_{SRC}) increases.

Thus, in the first embodiment, the time taken for writing into the pixel 32 is set on the basis of the size of the time constant. That is, the writing time is determined by adjusting a frequency of the main operation clock according to the size of the time constant. Furthermore, as shown in FIG. 8, the time taken for writing into the pixel 32 in one vertical period becomes shortened toward an upper line and becomes long toward a lower line.

As a specific control, as shown in FIG. 1, a line on which the pixels 32 that perform writing are arrayed is first expressed as a numeric value by the line counter 21 at the time of writing into the pixel 32. Then, the division ratio setting section 22 divides a comparison pulse on the basis of the numeric value indicating the position of a line corresponding to the pixels 32 that perform writing. Here, the lower the position of a line is, the lower the division ratio is. Accordingly, the lower the position of the line is, the lower the division ratio is. In addition, the main clock PLL circuit 23 generates a main operation clock from the comparison pulse. Accordingly, the main operation clock is generated to have a higher frequency in the case of a clock corresponding to writing into an upper line and a lower frequency in the case of a clock corresponding to writing into a lower line. Then, the main operation clock generated is output to the display unit 2 through the timing control circuit 16, the memory 14, and the analog driver 15.

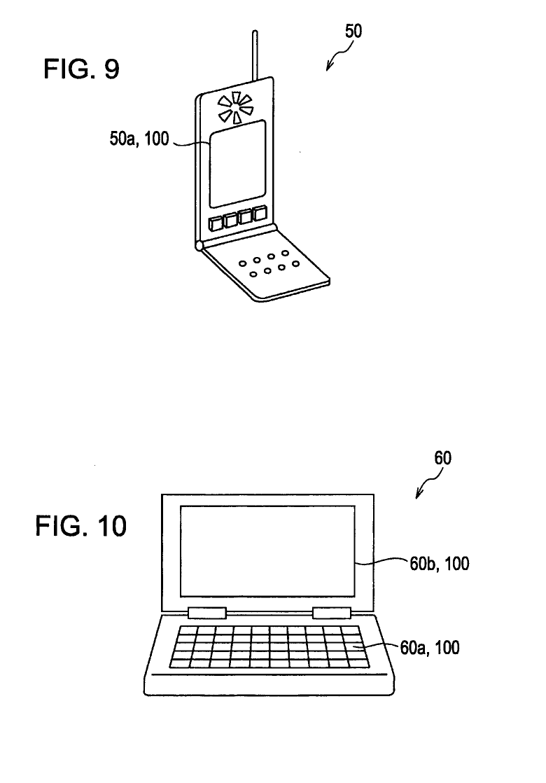

FIGS. 9 and 10 are views explaining examples of an electronic apparatus using the liquid crystal display device according to the first embodiment of the invention. Next, the electronic apparatus using the liquid crystal display device 100 according to the first embodiment of the invention will be described with reference to FIGS. 9 and 10.

The liquid crystal display device 100 according to one embodiment of the invention may be used in a mobile phone 50, a PC (personal computer) 60, and the like, as shown in FIGS. 9 and 10. In the mobile phone 50 shown in FIG. 9, the liquid crystal display device 100 according to the first embodiment of the invention is used for a display screen 50a. Moreover, in the PC 60 shown in FIG. 10, the liquid crystal display device 100 according to the first embodiment of the invention may be used for an input unit, such as a keyboard 60a, a display screen 60b, and the like. In addition, by providing peripheral circuits in a substrate of a liquid crystal panel, reduction in weight and miniaturization of the main body of the apparatus can be realized while greatly reducing the number of components.

In the first embodiment, as described above, driving based on the line sequential writing method is performed and the time taken for writing into the pixel 32 is controlled on the basis of the wiring resistance and wiring capacitance in the data line 37 for every line when the writing into the pixel 32 is performed. Accordingly, since the writing time is controlled on the basis of the wiring resistance and the wiring capacitance included in the data line 37, the time taken for writing into the pixel 32 can be easily set for every line. Furthermore, since the time taken for writing into the pixel 32 can be set for every line, it is possible to change the writing time of a video signal so as to be shortened according to the wiring resistance and the wiring capacitance included in the data line 32 without setting a writing period uniformly for all pixels 32. Accordingly, since it can be suppressed that a writing period longer than that required is set, the writing period can be shortened correspondingly.

Furthermore, in the first embodiment, a time taken for writing a video signal into the pixel 32 is made to change according to the distance (wiring resistance and wiring capacitance) of the data line 37 to each pixel 32. Accordingly, only a period required for each pixel 32 according to the distance of the data line 37 can be set as each writing period without uniformly setting a writing time, which is required for the pixel 32 having a longest transmission path of a video signal, as a writing period for each pixel 32. As a result, the total writing period can be shortened. Furthermore, since the time taken for writing into the pixel 32 is controlled on the basis of the wiring resistance and the wiring capacitance changing with the distance of the data line 37, the writing time required for the pixel 32 can be correctly set.

Furthermore, in the first embodiment, a control is made such that the writing time becomes long according to an increase (increase in the wiring resistance and wiring capacitance) in the distance of the data line 37 to the pixel 32 that performs writing. Therefore, according to the wiring resistance and wiring capacitance in the data line 37, the writing time can be set to be short for the pixel 32 having a short transmission path of a video signal and to be long for the pixel 32 having a long transmission path of a video signal.

Furthermore, in the first embodiment, the line of the pixels 32 in which writing is performed is expressed as a numeric value by the line counter 21. Therefore, the line of the pixels 32 in which writing is performed can be distinguished correctly. Furthermore, a required writing time can be easily controlled on the basis of the position of the line of the pixels 32 expressed as the numeric value by the line counter 21. In addition, since the time taken for writing into the pixel 32 is controlled for every line, it can be suppressed that a circuit becomes complicated compared with a case where the writing time is individually controlled for every pixel 32.

### Second Embodiment

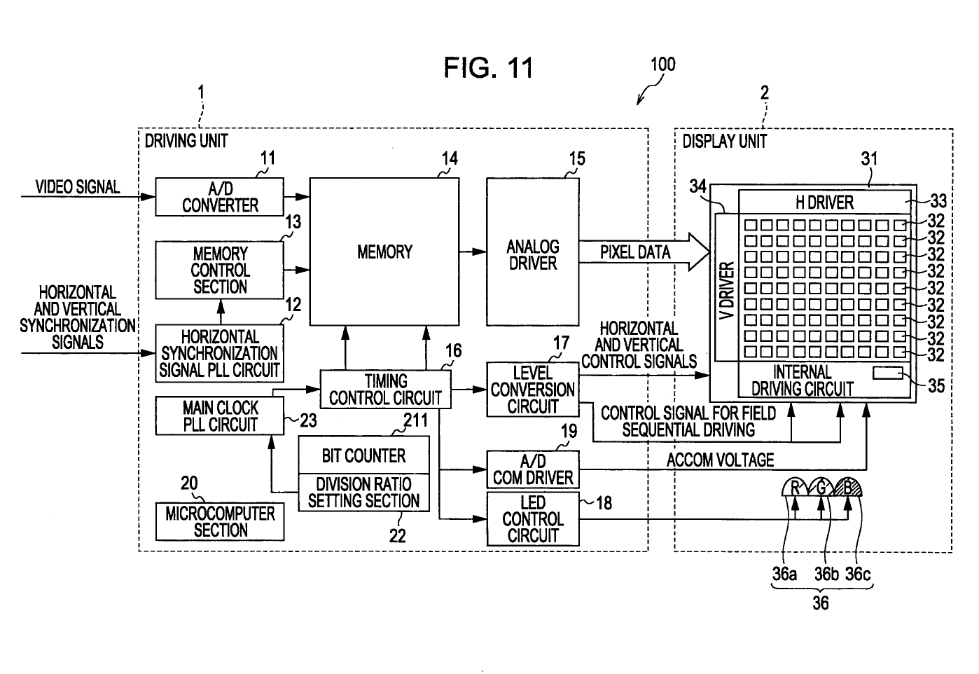

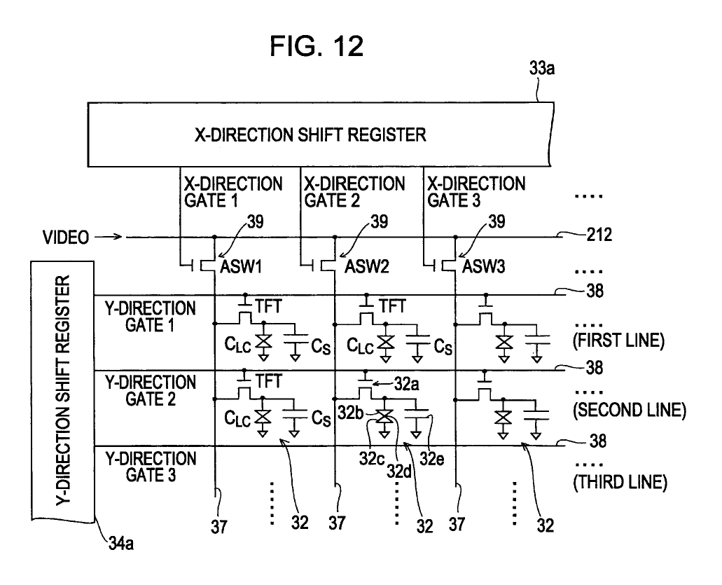

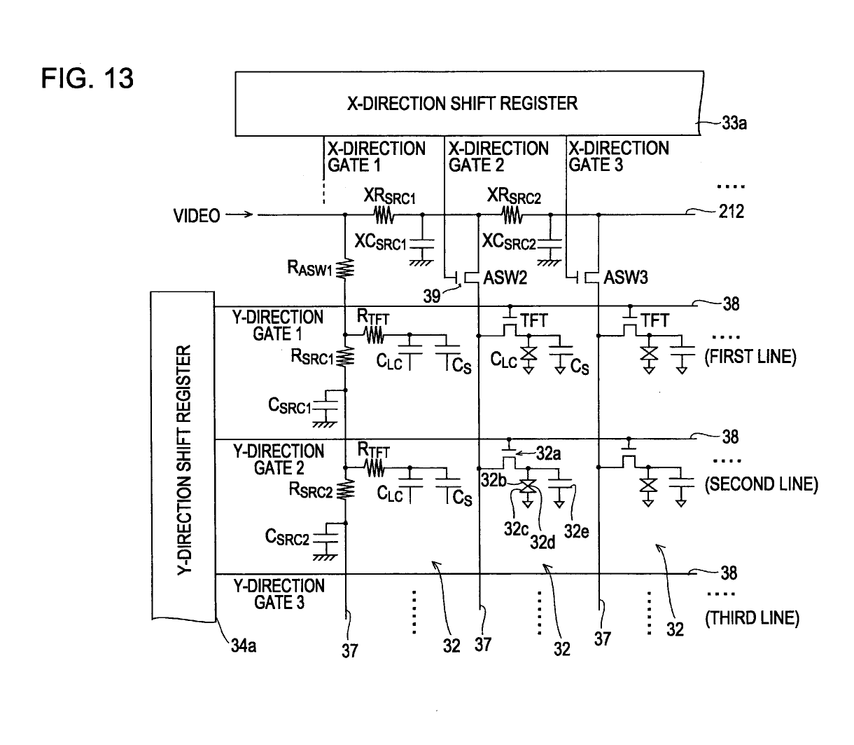

FIG. 11 is a block diagram illustrating the entire configuration of a liquid crystal display according to a second embodiment of the invention. FIGS. 12 and 13 are equivalent circuit diagrams illustrating a pixel portion of the liquid crystal display according to the second embodiment of the invention. Unlike the first embodiment in which the writing time is controlled for every line, an example in which the writing time is controlled for every pixel will be described with reference to FIGS. 11 to 13 in the second embodiment.

In a liquid crystal display 200 according to the second embodiment, a bit counter 211 having a function of converting the position of the pixel 32, which performs writing, into a numeric value for every pixel 32 is provided in a driving unit 1, as shown in FIG. 11. In addition, similar to the first embodiment, a data line 37 is connected to one terminal of a switch portion 39 formed of a TFT, as shown in FIG. 12. In addition, a video signal line 212 used to supply a video signal is connected to the other terminal of each switch portion 39. In addition, a gate of each switch portion 39 is connected to an X-direction shift register 33a provided in an H driver 33.

The other configurations in the second embodiment are equal to those in the first embodiment.

Moreover, in an operation at the time of writing of a video signal, only the switch portion 39 corresponding to a column to which an ON signal from the X-direction shift register 33a is supplied is turned on and only a pixel transistor 32a corresponding to a line to which an ON signal from an Y-direction shift register 34a is supplied is turned on, as shown in FIG. 12. This causes only one pixel 32 to be in a selected state (writable state), and writing is performed on the selected pixel 32.

As a specific control, first, the position of the pixel 32 where writing is performed is expressed as a numeric value by the bit counter 211 at the time of writing into the pixel 32, as shown in FIG. 11. Then, a division ratio setting section 22 divides a comparison pulse on the basis of the numeric value indicating the position of the pixel 32. Then, a main clock PLL circuit 23 generates a main operation clock from the comparison pulse. Here, the main operation clock is generated to have a higher frequency in the case of a clock corresponding to writing into the pixel 32 disposed in an upper line and an upper column and a lower frequency in the case of a clock corresponding to writing into the pixel 32 disposed in a lower line and a lower column. Then, the main operation clock generated is output to a display unit 2 through a timing control circuit 16, a memory 14, and an analog driver 15.

In the second embodiment, as described above, the position of the pixel 32 that performs writing is expressed as a numeric value for every pixel 32 by the bit counter 211 and the writing time of a video signal is made to change on the basis of the numeric value for every pixel 32. Accordingly, the writing time can be controlled according to the position of the pixel 32 that performs writing. Furthermore, since the writing time is controlled for every pixel 32, the writing time required for each pixel 32 at the time of writing can be controlled more finely.

Furthermore, in the second embodiment, driving based on a point sequential writing method is performed, and the writing time is controlled on the basis of the wiring resistance and the wiring capacitance included in the video signal line 212 and the data line 37 for every pixel 32 when writing into the pixel 32 is performed. This allows the writing time to be controlled on the basis of the wiring resistance and the wiring capacitance included in the video signal line 212 and the data line 37. As a result, the time taken for writing into each pixel 32 can be set easily.

In addition, the other effects in the second embodiment are equal to those in the first embodiment.

In addition, the embodiments described above are only illustrative at all points and should be considered not to be restrictive. The invention is not limited to the above-described embodiments, but all kinds of changes may be made without departing from the subject matter or spirit of the invention defined by the appended claims and their equivalents.

For example, although examples of using the LED (light-emitting diode element) as a light source for backlight have been described in the first and second embodiments, the invention is not limited thereto, but a light source for backlight other than the LED may also be used.

Furthermore, although an example in which the time taken for writing into a pixel is changed for every line has been described in the first embodiment, the invention is not limited thereto, but the writing time may also be changed for a plurality of lines. In this case, a circuit can be made simple compared with the case where the time taken for writing into a pixel is changed for every line.

Furthermore, in the first embodiment, examples of the electronic apparatus using the liquid crystal display device 100 according to the first embodiment have been shown in FIGS. 9 and 10. However, the invention is not limited thereto, but the liquid crystal display 200 according to the second embodiment may also be applied to the electronic apparatus.

Furthermore, although an example in which the writing time is changed for every pixel has been described in the second embodiment, the invention is not limited thereto, but the writing time may also be changed for a plurality of pixels. In this case, a circuit can be made simple compared with the case where the writing time is changed for every pixel.

What is claimed is:

1. A display device comprising:
a plurality of pixels,
wherein a time taken for writing a video signal into each of the pixels is changed according to the position of the pixel.

2. The display device according to claim 1, further comprising:
signal transmission lines for supplying video signals to the plurality of pixels,
wherein the time taken for writing a video signal into the pixel is changed according to a distance of each of the signal transmission lines to the pixel.

3. The display device according to claim 2,
wherein the time taken for writing into the pixel is controlled on the basis of wiring resistance and wiring capacitance of a signal transmission path of the signal transmission line up to the pixel.

4. The display device according to claim 2,
wherein a control is made such that a writing time becomes long according to an increase in the distance of the signal transmission path to the pixel.

5. The display device according to claim 2,
wherein driving based on a line sequential writing method of performing sequential writing for every line is performed for the plurality of pixels,
the signal transmission line includes a signal line for supplying a video signal to the pixel, and
when writing is performed on the pixels for every line, the time taken for writing into the pixel is controlled on the basis of wiring resistance and wiring capacitance changing with a distance of the signal line to the pixel.

6. The display device according to claim 2,
wherein driving based on a point sequential writing method of performing sequential writing for every pixel is performed,
the signal transmission line includes a signal line for supplying a video signal to the pixel and a video signal line for supplying a video signal to each signal line,
a switch portion provided between the video signal line and the signal line is further included, and
when writing is performed for every pixel, the time taken for writing into the pixel is controlled on the basis of wiring resistance and wiring capacitance changing with a distance of the video signal line to the signal line and a distance of the signal line to the pixel.

7. The display device according to claim 1, further comprising:
a counter that converts the position of the pixel into a numeric value; and
a division ratio setting section that divides a clock signal on the basis of the numeric value converted by the counter,
wherein the time taken for writing into the pixel is controlled by making the division ratio setting section perform division to a frequency corresponding to the position of the pixel converted into the numeric value by the counter.

8. The display device according to claim 7,
wherein the plurality of pixels are arrayed in a matrix,
the counter is configured to convert the position of the pixel into a numeric value for every line, and
the time taken for writing a video signal into the pixel is changed for every line on the basis of the numeric value converted for every line by the counter.

9. The display device according to claim 7,
wherein the plurality of pixels are arrayed in a matrix,
the counter is configured to convert the position of the pixel into a numeric value for every pixel, and
the time taken for writing a video signal into the pixel is changed for every pixel on the basis of the numeric value converted for every pixel by the counter.

10. The display device according to claim 1, further comprising:
a light-emitting device,
wherein the light-emitting device is configured to include a plurality of light sources corresponding to a plurality of emission colors, and
the plurality of light sources are controlled by field sequential driving controlled to be turned on in order for every color.

11. An electronic apparatus comprising the display device according to claim 1.
